(19) United States
(12) Patent Application Publication
(10) Pub. No.: US 2005/0142257 A1
(43) Pub. Date: Jun. 30, 2005

(54) Low carbohydrate fried food

(76) Inventors: James I. Long, Trophey Club, TX (US); John T. Johnson II, Arlington, TX (US)

Correspondence Address: MARK LEVY & ASSOCIATES, PLLC, PRESS BUILDING, SUITE 902, 19 CHENANGO STREET, BINGHAMTON, NY, 13901, US

(21) Appl. No.: 10/746,741

(22) Filed: Dec. 24, 2003

(51) Int. Cl. A23B 4/00

(52) U.S. Cl. 426/302

(57) ABSTRACT

A method for preparing a low-carbohydrate food product that is pleasing in appearance, and tasty, providing both the look and feel of conventional fried food. The method uses a liquid coating to cause a powdered hard cheese with specific properties to adhere to the surface of a foodstuff. The hard cheese coated foodstuff is then cooked, by pan frying, or deep frying. Foodstuffs including meat, freshwater fish, seafood, poultry, cheese, low-carbohydrate vegetables, as well as soy-based and synthetic protein foods. Other low-carbohydrate foodstuffs may be used in this invention. A variety of hard cheeses, and other cheeses, as well as cheese products including imitation cheese may be used to coat the foodstuff before preparation. The resulting food product has a crunchy, golden brown exterior, and is very tasty, providing a delicious food with small or negligible amounts of carbohydrate.

### FIELD OF THE INVENTION

This invention pertains to foodstuff and, more particularly to a method, recipe, and resulting product using a grated or powdered cheese to provide a low carbohydrate and low glycemic index fried food that is tasteful and appetizing.

### BACKGROUND OF THE INVENTION

Obesity in men, women and children has become a serious problem in certain cultures in recent history. This condition is typically accompanied by insulin resistance, high blood sugar, and high levels of undesirable blood lipids including Low Density cholesterol (LDL) associated with heart disease. Statistics show, for example, that in the United States, obesity has reached alarming levels in the last generation alone. A significant percentage of the population, young and old, are now overweight to a point of jeopardizing their health. Diabetes, for example, has been on the rise in all age groups. Its cause is very often attributed, at least in part, to obesity.

In response to this trend, many behavior modification programs have arisen and gained popularity. Almost all of them are based, at least partially, on the diet of the participants.

Over the years, conventional knowledge and advice have changed with new studies and theories. A food guide pyramid was endorsed by the United States Department of Agriculture (USDA) in the last century and now includes six food groups with the following daily serving quantities:
3 to 5 servings of vegetables
2 to 4 servings of fruits
2 to 3 servings of milk, yogurt and cheese
6 to 11 servings of bread, cereal, rice and pasta
2 to 3 servings of meat, poultry, fish, beans, eggs, nuts
fats, oils and sweets, only sparingly

What often began as simple calorie-counting diets have evolved into much more complex regimens, in which certain food groups must be balanced with other food groups, in which the time of day of consumption may be a factor, and in which physical exercise is often a crucial component.

One of the more straightforward diets was extolled and greatly popularized by the late Robert Atkins, M.D., whose various books sold consistently well over the last five years. The basic principle of the so-called Atkins diet, as opposed to the aforementioned food guide pyramid, relates to the reduction or elimination of carbohydrates (e.g., bread, pasta, sugar, and milk), and the increase of protein and fat. According to this diet, less than 20 g. of carbohydrates should be consumed per day in the initial stages. Once the human body enters a state known as ketosis, stored fat is metabolized. Accordingly, fat that was previously stored in the body is eliminated or burned off and muscle mass is increased.

Clinical studies including a Duke University study published at the 75^{th} annual AHA meeting, in November, 2002, show that the Atkins diet results in positive effects on weight, blood sugar levels, and blood lipids. In the Duke study, subjects were divided into two groups, half following the American Heart Association (AHA) Step 1, low-fat diet, and half following the Atkins diet. The Atkins dieters lost 31 pounds vs. the AHA dieters who lost 20 pounds, over the six week study period. In addition, the Atkins dieters experienced an 11 percent increase in HDL cholesterol, the “good” cholesterol, while the AHA dieters saw no increase. Both groups saw no change in LDL, while the Atkins dieters saw a drop of 50 percent in triglycerides, over twice the 22 percent drop seen by the AHA dieters. In another study, by physicians at Johns Hopkins Medical, reported at the 54^{th} Annual Meeting of the American Association for the Study of Liver Diseases in October, 2003, it was found that the high-carbohydrate, low-fat diet often recommended for overweight patients with fatty liver disease is in fact associated with increased liver inflammation.

In a perspective on the effects of changes in patterns of human nutrition on human health, researchers S. Boyd Eaton, M.D., and others, using forensic anthropological analysis of human remains before and after the onset of grain based agriculture ten thousand years ago, found that average height, bone density, and dental health deteriorated significantly with the change to a grain based pattern of nutrition. This change has also been found to be coincident with the onset of what are now considered to be typical age related diseases, including heart and vascular disease and diabetes, unusual before this change to grain consumption.

In the human diet, carbohydrates typically include starches. The monomeric unit of starch is glucose. In western countries, starch typically constitutes about 60% of carbohydrates consumed. Starch breakdown in the small intestine can be a quite rapid process so that the majority of the starch is broken down within one hour of entering the small intestine from the stomach.

When starch is digested in the small intestine it causes the level of glucose present in the blood to rise. The level of blood glucose in a healthy individual usually lies in the range 75-125 mg/100 ml. A greater blood glucose level can lead to heart, circulation, eye and kidney problems.

The highest point of the blood glucose level engendered by the indicated digestion of a food is known as the “glycemic response” of the food. The precise glycemic response of a food will vary according to the amount of food eaten and from individual to individual, depending upon such factors as the properties of the food, the efficiency of the individuals' digestive systems, and whether they suffer from diabetes.

With respect to digestion and health, it is important—as previously noted—for the blood glucose level of an individual to be controlled and not allowed to exceed a certain value. The two factors of greatest importance to enable this control are the activity of the liver and the balance of hormones. The liver has a certain autonomy. It is presently understood to have sensors which monitor blood glucose level. When the level is high, the liver removes glucose from the blood; when the level is low, it releases glucose into the blood.

In the hormonal regulation of blood glucose, the balance between insulin and glucagon is of prime importance. These two hormones are secreted by the pancreas in varying ratios, depending primarily upon the prevailing concentration of blood glucose. Any increase in the blood glucose level stimulates increased secretion of insulin. The problems experienced by diabetics include symptoms whose etiology are driven by higher than desirable blood glucose levels, as well as symptoms whose etiology are driven by higher than desirable insulin levels, drives by the concomitant insulin resistance typically experienced by prediabetic and diabetic individuals.

Some individuals are unable to control their blood glucose level by their own naturally produced insulin. This leads to the disease of diabetes. This disease is characterized by an above normal concentration of glucose in the blood. Diabetes is presently the third leading cause of death in the United States, where it kills 300,000 people per year. In 1950, there were 1.2 million diabetics in the United States, in 1975 there were 5 million diabetics and in 1991 there were more than 11 million diabetics. Accordingly, it is increasingly important to provide effective palliatives for the disease.

There are two types of diabetes which have different underlying causes. In Type 1 or insulin-dependent diabetes, there is an absolute deficiency of insulin and the patient may require regular injections of insulin to maintain glycemic control. In addition to insulin, diet and exercise must be carefully regulated in order to maintain good blood-sugar control.

In contrast, in Type 2 or non-insulin dependent diabetes, the pancreas is producing insulin, although it may not be doing so at normal levels. Although insulin is present, blood glucose levels are still abnormal because the body does not respond to it. Research conducted by Gerald Reaven, Stanford University, 1987, indicated that in approximately 25 percent of a normal population, insulin response to carbohydrates is blunted. In contrast, approximately 50 percent of a normal population respond with an elevated insulin response when they consume carbohydrates, and 25 percent have an extremely elevated insulin response to carbohydrates. As a result, 75% of the population is at risk from a high carbohydrate diet, and one third of these is at a high risk of developing detrimental health effects from a high carbohydrate diet. Of people who are diagnosed as having this form of diabetes, 80% are overweight. Some non-insulin dependent diabetics can control their condition through diet and exercise alone.

It is evident that prediabetics, diabetics, and perhaps 75% of the population at large should usually avoid foods having a high glycemic response, i.e., those which result in a relatively high level of blood glucose soon after digestion. Instead, diabetics require foods having a relatively low glycemic response which produce a slower rate of glucose release into the blood. Slowing the rate of release of glucose into the blood reduces the risk of both hyperglycemia and hypoglycemia.

Foods which only slowly release glucose into the blood stream may be advantageous in suppressing the appetite of an individual, and for assisting an individual to perform sustained physical activity. These types of food include proteins and fats, in contrast to high carbohydrate foods. Both these types of food result in a feeling of satiety, and thus discourage snacking and overeating.

Psychologically, most people grow impatient and dissatisfied with any radical change in their eating habits that persists over a relatively long period of time. Many find that foregoing the familiar tastes of what have been comfort foods, fried chicken, country fried steak, fried seafood, because of the high carbohydrate content of their conventional breading, is especially onerous. The repetitive use of a limited number of ingredients and foods results in cravings of exactly what is forbidden on the diet. Even recipes that are limited to low carbohydrate and/or high protein or high fat ingredients can become stale and unappetizing to the dieter. Eventually, many people discontinue the Atkins diet and other diets that limit carbohydrate and grain consumption, and return to the foods that resulted in the obesity in the first place, with concomitant returns to the conditions of insulin resistance, high blood sugar, excessive body weight, and unsatisfactory blood lipid levels.

### DISCUSSION OF PRIOR ART

While many forms of grain, flours and meals are currently being utilized as a breading for foods prior to frying, no known published information has been found regarding the use of grated, milled or powdered hard grating cheeses, imitation hard grating cheeses, or hard grating cheese blends as the sole or primary low carbohydrate coating or breading. No case wherein grated, milled or powdered hard grating cheeses, imitation hard grating cheeses, or hard grating cheese blends have been used to bread or coat raw meat, poultry, seafood or vegetables prior to frying in hot oil is known to the inventors.

Other soy and nut based flours and meals are currently being touted in low carbohydrate cookbooks and Internet recipes as a coating for fried foods; however, these alternates to conventional flours and meals tend to brown and discolor too quickly and excessively during the cooking process and do not impart the same color, texture and flavor as conventional, high carbohydrate fried food coatings and breadings. Grated, milled or powdered hard grating cheeses, imitation hard grating cheeses, and hard grating cheese blends darken much more slowly in the frying process, and allow the foodstuffs to be fully cooked during preparation while preserving the color, texture and flavor of the same foodstuffs which have been fried with conventional, high carbohydrate breadings.

### SUMMARY OF THE INVENTION

In accordance with the present invention, a method for preparing a low-carbohydrate food product that is pleasing in appearance, and tasty, providing both the look and feel of conventional fried food is presented.

The method comprises using a liquid coating to cause a powdered hard cheese with specific properties to adhere to the surface of a foodstuff. The hard cheese coated foodstuff is then cooked, by pan frying, or deep frying.

Foodstuffs including meat, freshwater fish, seafood, poultry, cheese, low-carbohydrate vegetables, as well as soy-based and synthetic protein foods, and other low-carbohydrate foodstuffs may be used in this invention. A variety of hard cheeses, and other cheeses, as well as cheese products including imitation cheese may be used to coat the foodstuff before preparation. The resulting food product has a crunchy, golden brown exterior, and is very tasty, providing a delicious food with small or negligible amounts of carbohydrate.

It would be advantageous to replace certain carbohydrate-laden ingredients with low-carbohydrate ingredients.

It would also be advantageous to use one or more substitutes for conventional, high-carbohydrate ingredients in recipes.

It would further be advantageous to provide substitutes for high-carbohydrate ingredients that are tasty, convenient and healthy.

It would also be advantageous to provide substitutes for high-carbohydrate ingredients that enhance the flavor and appearance of the remaining ingredients in the low-carbohydrate recipe.

It would also be advantageous to provide substitutes for high-carbohydrate ingredients alternatives that are high in protein.

### DETAILED DESCRIPTION OF THE PREFERRED EMBODIMENT

The present invention is a method for preparing a low-carbohydrate food product that is pleasing in appearance, and tasty, providing both the look and feel of conventional fried food. The method includes the use of low-carbohydrate foodstuffs including meat, freshwater fish, seafood, poultry, cheese, low-carbohydrate vegetables, as well as soy-based and synthetic protein foods, and other foodstuffs. These foodstuffs are prepared by coating with a hard cheese prior to cooking.

Hard cheese for this purpose includes those variety of cheeses classified as “very hard cheeses”, “hard grating cheeses” or “grana cheeses” in the U.S. Department of Agriculture 1976 Handbook 8-1, titled Composition of Food, Dairy and Egg Products; Ray Processed, Prepared. In this handbook, these cheeses are listed under the heading “Hard Grating Cheeses”. Parmesan and Romano cheese are both in this category. Several natural cheeses with a low carbohydrate value (carbohydrate value being defined as the difference between 100 and the sum of the percentage of water, protein, fat and ash) are also suitable as low carbohydrate coatings, and are included in the definition of hard cheese for this purpose, after the inherent moisture level of the cheese variety is reduced to below 32%. The relatively low moisture level renders the cheese suitable for grating, milling or powdering into small particles so that the finely divided cheese can be used in place of typical standard meal and flour configurations. These natural cheeses include Monterey Jack, Provolone, and Gorgonzola, which are normally classified as semi-soft cheeses, and Gruyere, which is normally found in the hard cheese category. Inasmuch as those skilled in the art will be familiar with other natural cheeses which can have their moisture content reduced to below 32% and can be used in this fashion, these are included within the scope of this invention.

In addition to the natural cheeses mentioned above, pasteurized, processed, and blended cheeses and imitation cheeses which can have their moisture content reduced to below 32% can also be utilized as the sole ingredient or primary ingredient in a low carbohydrate coating or breading as described in this invention.

The method of preparing the hard cheese thus defined for application to the foodstuff consists of conventional means of grating, milling, or powdering, to provide a finely divided material similar in consistency to conventional meal or flour.

The foodstuff is prepared for coating by cutting into appropriate size pieces, depending on the anticipated consumption of the prepared food as a snack or as meal portions. The foodstuff pieces are then wetted with a liquid comprising of portions of whole egg or egg albumin, a mixture of whole egg and egg albumin, or other binder known to those skilled in the art mixed together with water. In another embodiment, the edible oil may be added to the liquid mixture, to make a coating for foodstuff that will be subsequently cooked by means of pan frying, and therefore will have an appropriate taste after cooking as a result of the added oil. The foodstuff pieces are wetted by immersion or spraying with the liquid. Liquid in excess of the amount required to wet the foodstuff is allowed to drain off of the foodstuff pieces. Subsequently the liquid wetted foodstuff pieces are placed in contact with the finely divided hard cheese or hard cheese mixture, coating the pieces evenly on all surfaces. Some mechanical pressure may be used to bind the cheese mixture coating to the wetted surface of the foodstuff.

The hard cheese may be the sole constituent of the coating, or other ingredients, such as low carbohydrate soy and nut flours and meals, and various spices and extenders can be mixed with the finely divided hard cheese to make a less expensive, low carbohydrate coating and breading formulation, and also to impart different flavors and a different coloration, possibly a darker color, to the cooked foodstuff.

After the foodstuff has been coated with the hard cheese or hard cheese mixture, the coated foodstuff may then be cooked by a variety of methods including pan frying and deep frying. For storage, the coated foodstuff may be frozen before cooking. The coated foodstuff, in the preferred embodiment, is placed in a pan with preheated conventional frying oil, which may include canola oil, peanut oil, soy oil, sunflower oil, cottonseed oil, and other edible oils or combinations thereof, known to those skilled in the art, and cooked until the desired level of golden brown color and internal doneness is reached.

A two step deep frying procedure may be used, using a lower first frying temperature for a certain time, followed by a higher second frying temperature for the remainder of the cooking time. Such a two step procedure may result in less superheated steam generation in the food, as it is first immersed in the frying oil. This will be less disruptive to the coating on the food stuff, and is illustrated in the following examples.

Specific examples of this invention are as follows:

### EXAMPLE NUMBER 1

### Chicken

| Ingredients | Amount | |
|---|---|---|
| Chicken Breast Boneless/Skinless | 8 | oz. |
| Egg | 1 | |
| Water | 4 | oz |
| Salt | ⅛ | oz |
| Pepper | 1/16 | oz |
| Processed Parmesan Cheese, grated* | 4 | oz |
| Canola Oil** | 16 | oz |

Method of Preparation:

1. Cut chicken breast into 16 equal portions.

2. Mix egg and water in a stainless steel mixing bowl.

3. Mix parmesan cheese, salt and pepper in a stainless steel mixing bowl.

4. Place chicken portions into egg and water mixture and mix well, coating the chicken on all sides.

5. Remove and drain chicken from the egg and water mixture and place into the parmesan cheese mixture, coating all sides evenly.

6. Preheat the canola oil in a deep fat fryer to 325 degrees F. Gently place the coated chicken into the oil. After 3 minutes, increase the heat to 350 degrees F. Fry until golden brown, approx 6 minutes. Remove the fried chicken portions from the oil and drain well. Place chicken on paper towels to collect any excess oil and plate to serve.

Yield: one serving of fried chicken with less than 4 grams of carbohydrates. The chicken will be similar in texture to that of chicken fried in a conventional, high carbohydrate breading. The color of the finished chicken will grade a #3 on the McCormick Foods' Color Chart for Fried Foods.

*4 oz. is called for, although only enough is utilized to thoroughly coat.

**Canola Oil is specified, although any conventional frying oil can be substituted with similar results in texture, color and required cooking time.

### EXAMPLE NUMBER 2

### Fish

| Ingredients | Portion | |
|---|---|---|
| Cod Fish Filets | 8 | oz |
| Egg | 1 | |
| Water | 4 | oz |
| Salt | ⅛ | oz |
| Pepper | 1/16 | oz |
| Parmesan Cheese, grated, <25% moisture | 4 | oz |
| Soy Flour | 1 | oz |
| Canola Oil | 16 | oz |

Method of Preparation:

1. Mix parmesan cheese and soy flour in a stainless steel mixing bowl and set aside.

2. Mix egg and water in a stainless steel mixing bowl.

3. Cut cod fish in 4 equal portions and salt and pepper.

4. Place cod into the egg and water mixture and let stand.

5. Place the parmesan and soy flour mixture into a mixing bag and add the cod fish from the egg and water mixture. Shake until the fish is coated evenly.

6. Heat canola oil in a deep fat fryer to 325 degrees F. Add the coated cod fish gently to the hot oil fry for 3 minutes then increase the temperature to 350 degrees F. and continue frying until golden brown (approx 6 additional minutes). Remove from the hot oil and place on paper towel to collect the excess oil. Then plate for serving.

Yield: one serving of fried cod fish with less than 3 grams of carbohydrates. The fish will be similar in texture to that of fish fried with a conventional, high carbohydrate breading.

The color of the finished chicken will grade a #3 on the McCormick Foods' Color Chart for Fried Foods.

### EXAMPLE NUMBER 3

### Chicken Fried Steak

| Ingredients | Portion | |
|---|---|---|
| Round Steak tenderized | 8 | oz |
| Salt | ⅛ | oz |
| Pepper | 1/16 | oz |
| Egg | 1 | each |
| Water | 4 | oz |
| Parmesan Cheese, 19% moisture, grated | 4 | oz |
| Almond Flour | 1 | oz |
| Canola Oil | 8 | oz |

Method of Preparation:

1. Mix parmesan and almond Flour in a stainless steel mixing bowl and set aside.

2. Mix beaten egg and water in bowl.

3. Salt and pepper both side of the tenderized round steak and place in egg and water mixture.

4. Remove from the mixture and place in the Parmesan and flour mixture, coating both sides evenly. Repeat the process by placing the coated round steak back into the egg and water mixture, and then back into the parmesan and flour mixture to coat both sides evenly.

5. Pour canola oil into a 12 inch sauté pan and heat to 325 degrees F. Gently place the coated round steak into the pan and fry until golden brown. Turn the steak to fry the other side until golden brown. Repeat if necessary to complete the cooking process. Remove from the pan and place on a paper towel to remove excess oil. Plate to serve.

Yield: one portion of chicken fried steak with less than 5 grams of carbohydrates. The fried steak will be similar in texture to that of round steak fried in a conventional, high carbohydrate breading. The color of the finished steal will grade a #3 on the McCormick Foods' Color Chart for Fried Foods.

### EXAMPLE NUMBER 4

### Mixed Vegetables

| Ingredients | Portion | |
|---|---|---|
| Large White Mushrooms | 3 each cut in half | |
| Zucchini squash | 4 each cut in ¼ | |
| | inch slices | |
| Yellow Squash | 4 each cut in ¼ | |
| | inch slices | |
| Salt | ⅛ | oz |
| Pepper | 1/16 | oz |
| Egg | 1 | |
| Water | 4 | oz |
| Processed Parmesan/Romano Cheese | 4 | oz |
| Canola Oil | 16 | oz |

Method of Preparation:

1. Mix beaten egg and water in a stainless steel mixing bowl and set aside.

2. Clean mushrooms and squash thoroughly and cut into the desired shape.

3. Place on paper towels and dry then add to the egg and water mixture.

4. Place cheese mixture into a mixing bag and add the vegetables. Shake bag until the vegetables are thoroughly coated.

5. Heat oil in a deep fat fryer until 350 degrees F. Add coated vegetables and cook until golden brown (approx 6 minutes). Remove from oil and place on paper towels to collect excess oil. Salt and pepper to taste. Plate to serve.

Yield: one serving with 14 pieces of fried mixed vegetables. Serving will contain less than 6 grams of carbohydrates. The vegetables will be similar in texture to that of vegetables fried in a conventional, high carbohydrate breading. The color of the finished vegetables will grade a #3 on the McCormick Foods' Color Chart for Fried Foods.

### EXAMPLE NUMBER 5

### Fried Cheese Strips

| Ingredient | Portion | |
|---|---|---|
| Mozzarella Cheese | 4 | oz., |
| | cut into ½ inch diameter | |
| | strips, 4″ long | |
| Egg | 1 | |
| Water | 4 | oz |
| Parmesan Cheese, 19% moisture | 4 | oz |
| Canola Oil | 16 | oz |

Method of Preparation:

1. Mix egg and water in a stainless steel mixing bowl and set aside

2. Place cheese strips in egg and water mixture.

3. Place Parmesan into a mixing bag and add the cheese strips. Shake bag until the cheese strips are thoroughly coated.

4. Heat oil in a deep fat fryer until 350 degrees, add coated cheese and cook until golden brown (approx. 2 minutes).

5. Remove from oil and place on paper towels to remove excess oil. Salt and pepper to taste.

Yield: one serving of fried cheese strips with less than 3 grams of carbohydrates. The chicken will be similar in texture to that of cheese fried in a conventional, high carbohydrate breading. The color of the finished cheese will grade a #2 on the McCormick Foods' Color Chart for Fried Foods.

### EXAMPLE 6

### Shrimp

| Ingredient | Portion | |
|---|---|---|
| Shrimp, 21-25 ct raw | 12 | |
| Egg | 1 | |
| Water | 4 | oz. |
| Salt | ⅛ | oz |
| Pepper | 1/16 | oz |
| Dried blend of Mozzarella, Swiss and | 4 | oz |
| Gruyere Cheese processed and grated to | | |
| form an imitation Parmesan product | | |
| Canola Oil | 16 | oz |

Method of Preparation:

1. Mix cheese, salt and pepper and place into a mixing bag.

2. Mix egg and water together in a stainless steel mixing bowl.

3. Peel and clean shrimp. Butterfly large end on shrimp and press flat.

4. Place shrimp into the egg and water mixture and cover completely.

5. Remove shrimp from the egg/water mixture and place into the mixing bag. Shake the bag until shrimp are thoroughly coated.

6. Heat oil in a deep fat fryer until 325 degrees F. Add shrimp and fry for 3 minutes. Increase the temperature to 350 degrees F. and fry until golden brown, approximately 4 more minutes. Remove and place on paper towels to remove the excess oil. Salt and pepper to taste. Plate for serving.

Yield: one serving of fried shrimp, 12 pieces with less than 3 total grams of carbohydrates. The shrimp will be similar in texture to that of shrimp fried in a conventional, high carbohydrate breading. The color of the finished shrimp will grade a #6 on the McCormick Foods' Color Chart for Fried Foods.

Since other modifications and changes varied to fit particular operating requirements and environments will be apparent to those skilled in the art, the invention is not considered limited to the examples chosen for purposes of disclosure and covers all changes and modifications which do not constitute departures from the true spirit and scope of the invention.

Having thus described the invention, what is desired to be protected by Letters Patent is presented in the subsequently appended claims.

1. A method for preparing a low-carbohydrate edible food product, the steps comprising:
a) providing a foodstuff from the group: meat, soy-based items, fish, poultry, synthesized protein items, low-carbohydrate vegetables, and cheese;
b) coating said foodstuff with a hard cheese; and
c) cooking said foodstuff with said hard cheese coating by one of the group: pan frying, and deep frying.

2. The method for preparing a low-carbohydrate edible food product in accordance with claim 1, wherein said hard cheese is chosen from the group: parmesan, romano, provolone, cheddar, and imitation cheese.

3. The method for preparing a low-carbohydrate edible food product in accordance with claim 2, the steps further comprising grating said hard cheese prior to performing said coating step (b).

4. The method for preparing a low-carbohydrate edible food product in accordance with claim 3, wherein said hard cheese is finely divided using a technique selected from the group: grating, milling, and powdering.

5. The method for preparing a low-carbohydrate edible food product in accordance with claim 1, the steps further comprising:
d) dipping said foodstuff in a liquid prior to said coating step (b).

6. The method for preparing a low-carbohydrate edible food product in accordance with claim 5, wherein said liquid is chosen from the group: a mixture of beaten whole egg and water, a mixture of egg albumin and water, a mixture of whole egg together with egg albumin and water.

7. A low-carbohydrate edible food product made in accordance with claim 3.

8. A low-carbohydrate edible food product made in accordance with claim 6.

9. A process for preparing a low-carbohydrate edible food product, the elements of said recipe comprising:
a) selecting a foodstuff from the group: meat, soy-based items, freshwater fish, seafood, poultry, synthesized protein items, low-carbohydrate vegetables, and cheese;
b) selecting a hard cheese from the group: parmesan, romano, provolone, cheddar, gorgonzola, gruyere, and imitation cheese;
c) drying said hard cheese to a moisture content below 32 percent;
d) preparing said hard cheese in a finely divided from by using a technique selected from the group: grating, milling, and powdering;
e) coating said foodstuff with a liquid selected from the group: a mixture of beaten whole egg and water, a mixture of egg albumin and water, a mixture of whole egg together with egg albumin and water;
f) breading said coated foodstuff with said finely divided hard cheese; and
g) cooking said coated and breaded foodstuff by using a technique selected from the group: pan frying, and deep frying.

10. A low-carbohydrate edible food product made in accordance with claim 9.

11. The process in accordance with claim 9, wherein said cooking step (g) comprises heating said foodstuff at a first predetermined temperature for a first predetermined time duration and thereafter heating said foodstuff at a second predetermined temperature for a second predetermined time duration.

12. The process in accordance with claim 9, wherein said coating step (e) further comprises adding a predetermined amount of edible cooking oil to said liquid.

13. The process in accordance with claim 12, wherein said breading step (f) further comprises freezing said breaded foodstuff, for storage before cooking.

14. The method in accordance with claim 1, wherein said coating step (b) further comprises freezing said breaded foodstuff, for storage before cooking.

15. The method in accordance with claim 6, wherein said liquid further comprises adding a predetermined amount of edible cooking oil to said liquid.
